(19) United States
(12) Patent Application Publication
(10) Pub. No.: US 2015/0082232 A1
(43) Pub. Date: Mar. 19, 2015

(54) GRAPHIC USER INTERFACE FOR MULTI-PAGE IMAGE PRODUCT

(71) Applicant: Shutterfly, Inc., Redwood City, CA (US)

(72) Inventor: Eric Ross Baker Wood, Menlo Park, CA (US)

(73) Assignee: Shutterfly, Inc., Redwood City, CA (US)

(21) Appl. No.: 14/030,326

(22) Filed: Sep. 18, 2013

(51) Int. Cl. G06F 3/0482; G06F 3/0483; G06F 3/0488; G06F 3/0484

(52) U.S. Cl. CPC G06F 3/0482; G06F 3/04842; G06F 3/0483; G06F 3/0488
USPC 715/779

(57) ABSTRACT

A computer-implemented method is disclosed for a user to view image product at a graphic user interface. The method includes displaying an image representation of a multi-page product in a page view at a graphic user interface, allowing a user to select the image representation in the page view, enabling display by a computer system, in the same page view, of a navigation panel in association with the image representation, wherein the navigation panel provides a plurality of selections each associated with one or more pages in the multi-page product, allowing the user to make a first selection in the navigation panel in the page view, displaying first one or more pages of the multi-page product in the same page view according to the first selection, and removing the display of the navigation panel in the same page view when the multi-page product is deselected by the user.

### TECHNICAL FIELD

This application relates to utilization of digital images, and more specifically, to a graphic user interface for viewing image product.

### BACKGROUND OF THE INVENTION

Digital images can be stored in user's computers and viewed on electronic display devices. Users can upload digital images to a central network location provided by image service providers such as Shutterfly, Inc. Such image service providers can enable users to store, organize, manage, edit, enhance, and share digital images at the central network location using a web browser or other software applications. A user can also design and personalize image-based products, and order the image-based products from the image service provider. Examples of the image-based products include image prints, photo books, photo calendars, photo greeting cards, holiday cards, photo stationeries, photo mugs, and photo T-shirts, which incorporate image content provided by the user or the image service provider.

The proliferation of mobile devices such as camera phones and tablet computers enables an increasing number of users to take pictures, share photos, post photos online, and create personalized photo products or projects. Creating personalized image products, however, can take considerable amount of time and effort. Additionally, it is challenging to personalize image products using mobile devices because these devices often have smaller displays, lower communication bandwidth, and possibly have lower computing power comparing to desk computers. Users of mobile devices also tend to have shorter attention span than users of desktop or laptop computers.

There is therefore a need for more convenient tools to view image designs and image products, especially on mobile devices.

### SUMMARY OF THE INVENTION

The present application disclosed a novel computer-implemented method for displaying an image product comprising multiple pages. The disclosed method simplifies the multiple view pages in conventional methods into display objects in a single view page. The disclosed method is intuitive, more convenient to use, and responds faster to user commands. The disclosed method can be beneficial for applications on mobile devices such as smart phones.

In one general aspect, the present invention relates to a computer-implemented method for a user to view image product at a graphic user interface. The method includes displaying an image representation of a multi-page product in a page view at a graphic user interface; allowing a user to select the image representation in the page view; in response to user's selection of the image representation, enabling display by a computer system, in the same page view, of a navigation panel in association with the image representation, wherein the navigation panel provides a plurality of selections each associated with one or more pages in the multi-page product; allowing the user to make a first selection in the navigation panel in the page view; displaying first one or more pages of the multi-page product in the same page view according to the first selection; and removing the display of the navigation panel in the same page view when the multi-page product is deselected by the user.

Implementations of the system may include one or more of the following. The computer-implemented method can further include allowing the user to make a second selection in the navigation panel in the page view, and displaying second one or more pages of the multi-page product in the same page view according to the second selection. The step of allowing a user to select the image representation can include tapping a touch sensitive display device by the user. The step of allowing a user to select the image representation can include moving a cursor over the image representation by the user. The computer-implemented method can further include in response to user's selection of the image representation, enabling display, in the same page view, of a page layout in association with the image representation and the navigation panel, wherein the first one or more pages of the multi-page product can be displayed in the page layout. The page layout can be displayed over the image representation. The computer-implemented method can further include displaying the image representation of the multi-page product in the same page view when the multi-page product is deselected by the user. The page layout can be associated with a single page of the multi-page product. The page layout can be associated with two opposing pages of the multi-page product. The one or more pages of the multi-page product can include at least one of a photo or personalized text. The computer-implemented method can further include displaying image representations of a plurality of image products including the multi-page product in the page view. The plurality of image products can include a photobook, a photo calendar, a photo greeting card, a multi-panel greeting card, photo stationery, a phone case, a photo mug, an image print, a photo magnet, a photo coaster, or a photo mouse pad. The navigation panel can include a linear array of grids that define the plurality of selections each associated with one or more pages in the multi-page product. The navigation panel can include a two-dimensional array of grids that define the plurality of selections each associated with one or more pages in the multi-page product. The image representation can include a thumbnail image of the multi-page product. The image representation can include a front cover of the multi-page product. The image representation can be a perspective view of the multi-page product. The computer system can include a mobile device. The graphic user interface can be enabled by a web browser, a client application, or a native application. The page view can include a web page in a web browser or a screen on a device.

These and other aspects, their implementations and other features are described in detail in the drawings, the description and the claims.

### BRIEF DESCRIPTION OF THE DRAWINGS

FIG. 1 is a block diagram of a network-based imaging service system compatible with the present invention.

FIG. 2 shows a process to allow a user to view a multi-page image product at a graphic user interface in accordance to the present invention.

FIG. 3 shows a page view at a graphic user interface including an image representation of a multi-page image product.

FIG. 4 is shows a navigation panel and displaying of one or more pages of the multi-page image product based on a selection in the navigation panel in the same page view at the graphic user interface.

FIG. 5 is shows a navigation panel and displaying of one or more different pages of the multi-page image product based on a different selection in the navigation panel in the same page view at the graphic user interface.

### DETAILED DESCRIPTION OF THE INVENTION

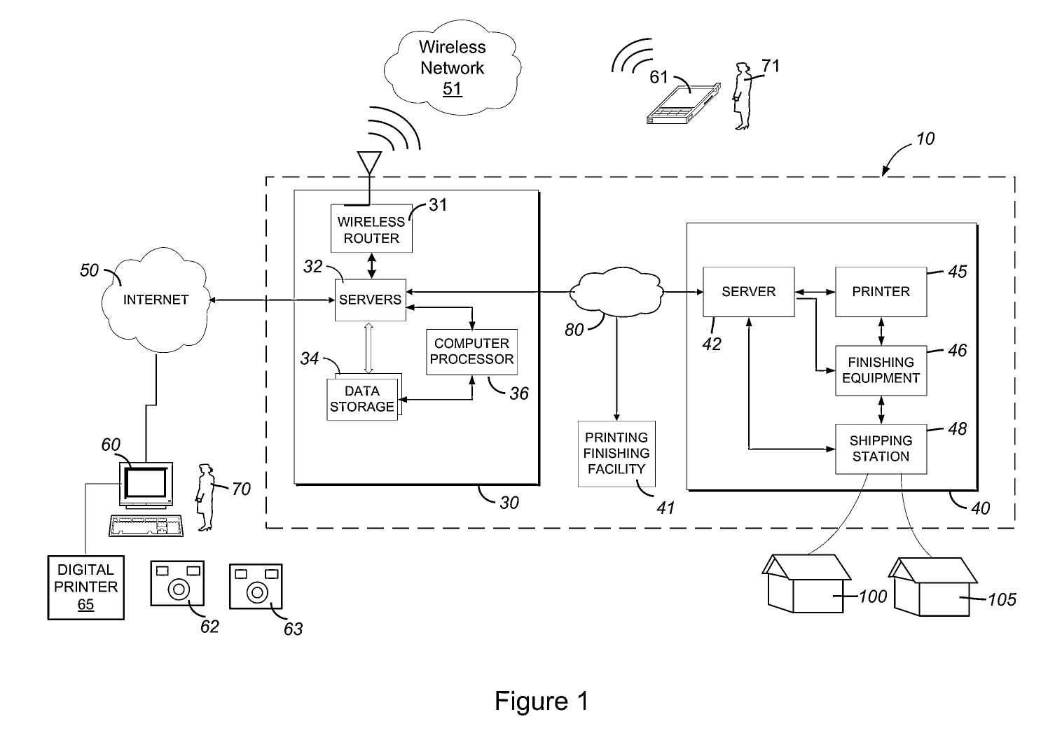

Referring to FIG. 1, an imaging service system 10 can enable users 70, 71 to organize and share images via a wired network or a wireless network 51. Optionally, the imaging service system 10 can also fulfill image products for the users 70, 71. The imaging service system 10 includes a data center 30, one or more product fulfillment centers 40, 41, and a computer network 80 that facilitates the communications between the data center 30 and the product fulfillment centers 40, 41.

The data center 30 can include a server 32 for communicating and receiving input from the users 70, 71, a data storage device 34 for storing user data, image and design data, and a computer processor 36 for rendering images, organizing images, and processing orders. The user data can include account information, discount information, and order information associated with the user. A website can be powered by the servers 32 and can be accessed by the user 70 using a computer device 60 via the Internet 50, or by the user 71 using a wireless device 61 via the wireless network 51.

The imaging service system 10 allows users to design and personalize their products. In the present disclosure, the term “personalized” refers to the information that is specific to the recipient, the user, the gift product, and the occasion, which can include personalized content, personalized text messages, personalized images, and personalized designs that can be incorporated in the image products. The content of personalization can be provided by a user or selected by the user from a library of content provided by the service provider. The term “personalized information” can also be referred to as “individualized information” or “customized information”.

Personalized image products can include users' photos, personalized text, personalized designs, and content licensed from a third party. Examples of personalized image products may include photo books, personalized greeting cards, photo stationery, photo or image prints, photo posters, photo banners, photo playing cards, photo T-shirts, photo mugs, photo aprons, photo magnets, photo mouse pads, a phone case, a case for a tablet computer, photo key-chains, photo collectors, photo coasters, photo banners, or other types of photo gifts or novelty items. Photo book generally refers to as bound multi-page product that includes at least one image on a book page. Photo books can include photo albums, scrapbooks, bound photo calendars, or photo snap books, etc. The image products each can include a single page or multiple pages. Each page can include one or more images, text, and design elements. Some of the images may be laid out in an image collage.

The user 70 or her family may own multiple cameras 62, 63. The user 70 transfers images from cameras 62, 63 to the computer device 60. The user 70 can edit, organize images from the cameras 62, 63 on the computer device 60. The computer device 60 can be in many different forms: a personal computer, a laptop, or tablet computer, a mobile phone etc. The camera 62 can include a camera that is integrated with or built-in in the computer device 60. The user 70 can also print pictures using a printer 65 and make image products based on the images from the cameras 62, 63. The cameras 62, 63 can include a digital camera, a camera phone, a video camera capable of taking still images, or an image capture device installed on a laptop computer or a tablet computer. The images from the cameras 62, 63 can be uploaded to the server 32 to allow the user 70 to organize and render images at the website, share the images with others, and design or order image product using the images from the cameras 62, 63 or elsewhere.

Examples for the wireless device 61 include a mobile phone, a tablet computer, or a laptop computer, personal digital assistant, etc. The wireless device 61 can include a built-in camera (e.g. in the case of a camera phone). The images taken by the user 71 using the wireless device 61 can also be uploaded to the data center 30. If users 70, 71 are members of a family or associated in a group (e.g. a soccer team), the images from the cameras 62, 63 and the mobile device 61 can be grouped together to be incorporated into an image product such as a photo book, or used in a blog page for an event such as a soccer game.

Once an image product design is created, a user can order it from the image service provider. The image product design and associated data can be transmitted to the server 42 in the product fulfillment center 40. The image product can be printed by a printer 45, finished by finishing equipment 46, and shipped to locations 100, 105 from shipping station 48. The finished image products can be shipped to the user herself, or as gifts to other recipients.

Although large numbers of photos are frequently captured by various devices, only a small fraction of the digital images are used in customized imaging products. This diversion becomes especially prominent in mobile devices: a vast majority of photos captured by smart camera phones are not used in creative image products or image project designs. Such diversion is caused in part by a lack of tools to assist users to quickly create personalized image product designs in a small display, short user-attention, and often low communication-bandwidth environment.

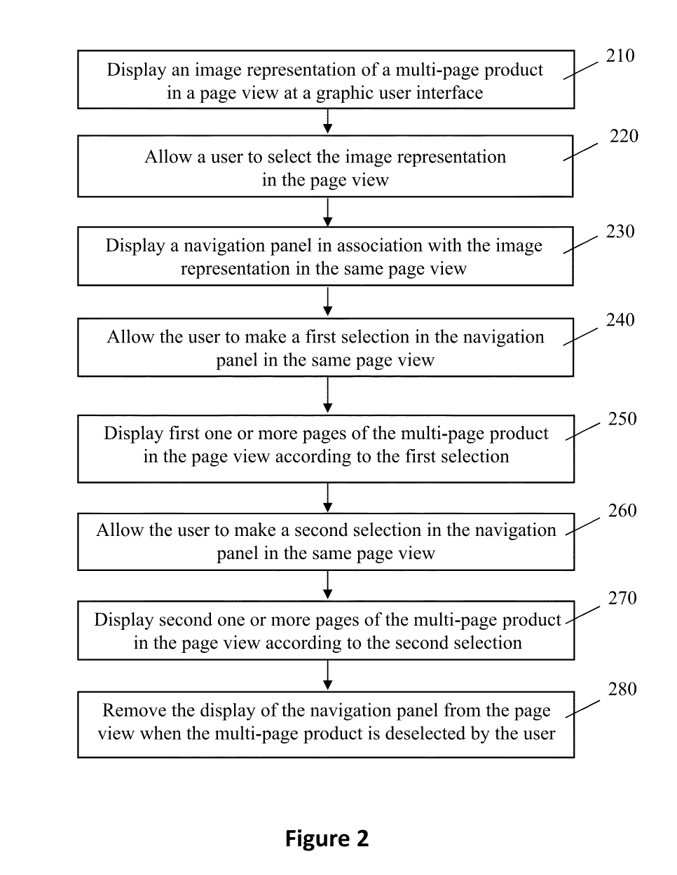

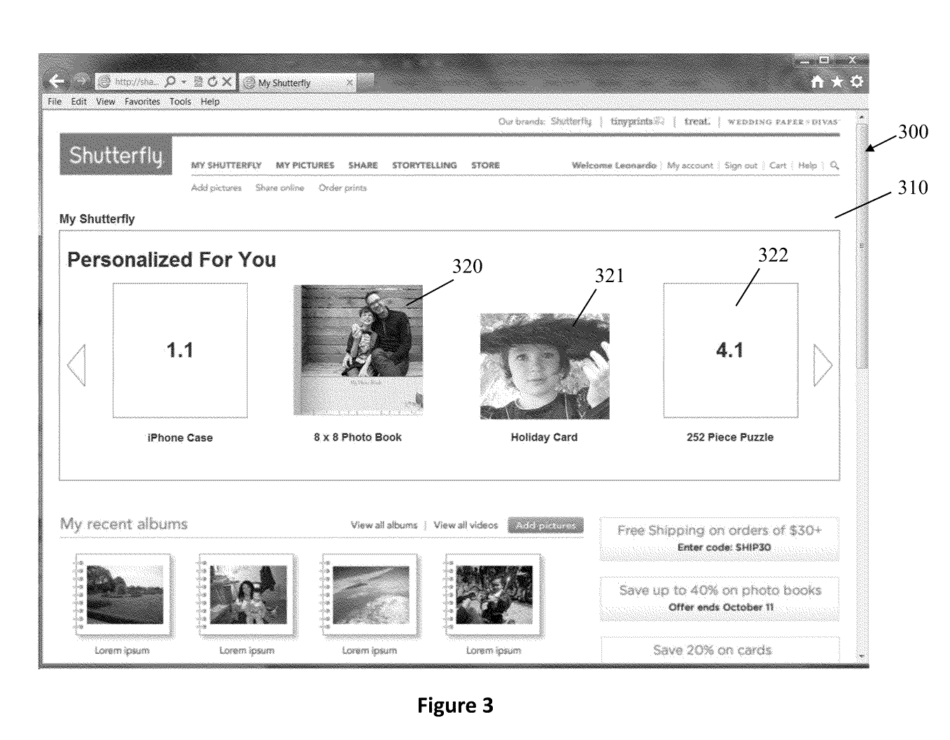

Referring to FIGS. 2 and 3, a page view 310 is displayed at a graphic user interface 300. The page view 310 includes the display of an image representation 320 that represents a multi-page product (step 210). The page view 310 can also display other image products such as a holiday card 321, a puzzle 322. Other image products that can be displayed include a photo greeting card, a photo calendar, photo stationery, a phone case, a photo mug, a photo T-shirt, a photo apron, an image print, a photo magnet, a photo coaster, a photo mouse pad, a key chain, a photo collector, or other types of photo gifts or novelty items. The graphic user interface 300 can be displayed at a computer device (e.g. 60 in FIG. 1), a wireless device (e.g. 61 in FIG. 1), and other types computing or communication devices. For example, the graphic user interface 300 can be provided by a web browser, a client application, or a native application such as mobile application for mobile phones, tablet computers, etc. The term “a page view” refers to a single page or a single screen at a graphic user interface. For example, a page view can refer to a web page in a web browser, or a screen enabled by a native application on a mobile device.

Examples of multi-page image product include a photobook, a photo calendar, a multi-panel photo greeting card, etc. For example, the multi-page image product is exemplified by an 8×8 Photo Book in FIG. 3. The image representation 320 for the multi-page product can be a thumbnail image such an image of the front cover of the multi-page product. The image representation 320 can be a two-dimensional view and a three-dimensional perspective view of the multi-page product.

A user can request to see the multi-page product by selecting the image representation 320 in the page view 310 (step 220). The selection can be made by moving a cursor over the image representation 320, which can be accomplished using a mouse (i.e. a command that is sometimes called “mouse over”), a touch pad, a stylus, or eye tracking (e.g. gaze tracking), etc. For example, a cursor can be moved by one of the above methods over the image representation 320 to indicate the selection. On a touch sensitive display, the selection can also be done by user's hand tapping the image representation 320 on the display device.

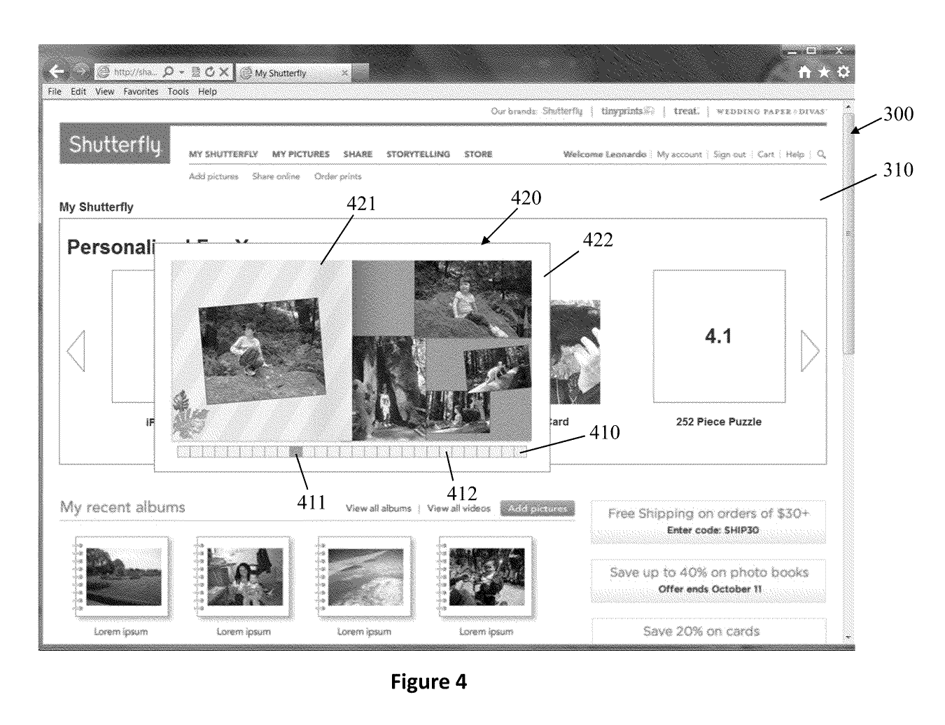

In response to the selection of the multi-page product by the user, referring to FIGS. 2 and 4, a navigation panel 410 and a book page layout 420 dynamically appear in the same page view 310 in association with the image representation (step 230). The navigation panel 410 can be implemented in a linear array (i.e. a navigation bar) as shown in FIG. 4, or in a two-dimensional array. The navigation panel 410 can include a grid of a plurality of selections each corresponding to one or more pages. The user can select one grid 411 in the navigation panel 410 by mouse over and tapping the grid 411 in the same page view 310 (step 240). The one or more product pages 421, 422 are displayed according to the selection of the grid 411 in the book page layout 420 (step 250). The product pages 421, 422 can include one or more photos and personalized text provided by the user.

The book page layout 420 can hold two opposing pages, as shown, or a single page of the multi-page product (e.g. a photobook). In some implementations, as shown in FIG. 4, the navigation panel 410 and the book page layout 420 are displayed over the image representation 320 (FIG. 3) in the page view 310, which not only visually relates the navigation panel 410 and the book page layout 420 to the multi-page image product but also saves space for the continued displaying of other objects in the graphic user interface 300.

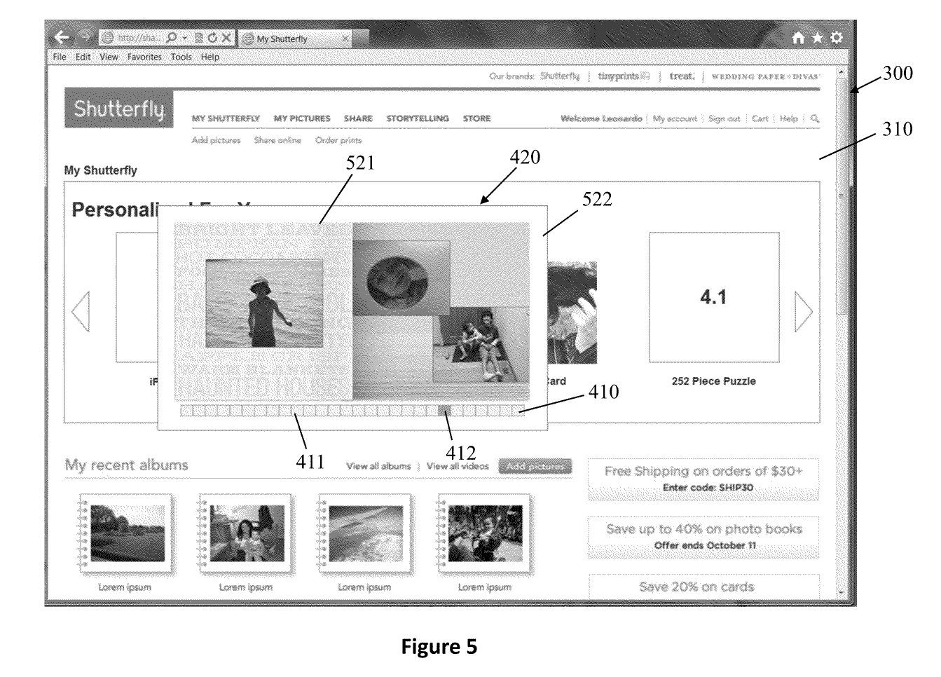

Referring to FIGS. 2 and 5, the user can select a different grid 412 in the navigation panel 410 (step 260). Different product pages 521, 522 are displayed according to the selection of the grid 412 in the book page layout 420 (step 270). The product pages 421, 422 can be refreshed by the product pages 521, 522, or alternatively, the pages turn continuously from the product pages 421, 422 to the product pages 521, 522.

The user can deselect the multi-page product by moving the cursor or touch outside the book page layout 420. Once it is deselected, the navigation panel 410 and the book page layout 420 are removed from the page view 310; the image representation 320 of the multi-page product is again displayed in the same page view 310 (step 280), as shown in FIG. 3.

It should be noted that the navigation panel in the disclosed method differs from the scroll bar for book reading in that the disclosed navigation panel appears in the same view page at user's command—only when the user wants to see details of a multi-page image product. When one multi-page image product is not viewed, the navigation panel disappears to allow other products (e.g. holiday card 321, puzzle 322, etc. shown in FIG. 3) to be viewed in detail.

In some embodiments, the image representation 320 (FIG. 3) can represent an image product having different perspective views. The navigation panel 410 (FIG. 4) can be used by a user to select different perspective views of the image product.

In some embodiments, the image representation 320 (FIG. 3) can represent a group of image product designs. The navigation panel 410 (FIG. 4) can be used by a user to select different image product designs. The group of image products can include a product with the same design but having different pictures. For example, a group of greeting card designs can be based on the same card layout but incorporating different images from the user. The images can be stored in the data storage device 34 in the data center 30 (FIG. 1). Similarly, a group of greeting card designs can be based on different card layouts but incorporating a same image from the user.

An advantage of the presently disclosed method is that it allows a user to view details of a multi-page image product without leaving a page. It is known that users can be lost or decide to abort session when they have to switch among multiple pages to view different products. The disclosed method of product viewing thus becomes less confusing and time consuming for the users. There can be several image products presented in the same page, each of which can be viewed in detail in the same page.

It should be understood that the presently disclosed systems and methods can be compatible with different devices, different image products, different user interfaces, or different software formats other than the examples described above.

What is claimed is:

1. A computer-implemented method for a user to view image product at a graphic user interface, comprising:
displaying an image representation of a multi-page product in a page view at a graphic user interface;
allowing a user to select the image representation in the page view;
in response to user's selection of the image representation, enabling display by a computer system, in the same page view, of a navigation panel in association with the image representation, wherein the navigation panel provides a plurality of selections each associated with one or more pages in the multi-page product;
allowing the user to make a first selection in the navigation panel in the page view;
displaying first one or more pages of the multi-page product in the same page view according to the first selection; and
removing the display of the navigation panel in the same page view when the multi-page product is deselected by the user.

2. The computer-implemented method of claim 1, further comprising:
allowing the user to make a second selection in the navigation panel in the page view; and
displaying second one or more pages of the multi-page product in the same page view according to the second selection.

3. The computer-implemented method of claim 1, wherein the step of allowing a user to select the image representation comprises tapping a touch sensitive display device by the user.

4. The computer-implemented method of claim 1, wherein the step of allowing a user to select the image representation comprises moving a cursor over the image representation by the user.

5. The computer-implemented method of claim 1, further comprising:
in response to user's selection of the image representation, enabling display, in the same page view, of a page layout in association with the image representation and the navigation panel,
wherein the first one or more pages of the multi-page product are displayed in the page layout.

6. The computer-implemented method of claim 5, wherein the page layout is displayed over the image representation.

7. The computer-implemented method of claim 6, further comprising:
displaying the image representation of the multi-page product in the same page view when the multi-page product is deselected by the user.

8. The computer-implemented method of claim 5, wherein the page layout is associated with a single page of the multi-page product.

9. The computer-implemented method of claim 5, wherein the page layout is associated with two opposing pages of the multi-page product.

10. The computer-implemented method of claim 1, wherein the one or more pages of the multi-page product include at least one of a photo or personalized text.

11. The computer-implemented method of claim 1, further comprising:
displaying image representations of a plurality of image products including the multi-page product in the page view.

12. The computer-implemented method of claim 11, wherein the plurality of image products include a photobook, a photo calendar, a photo greeting card, a multi-panel greeting card, photo stationery, a phone case, a photo mug, an image print, a photo magnet, a photo coaster, or a photo mouse pad.

13. The computer-implemented method of claim 1, wherein the navigation panel includes a linear array of grids that define the plurality of selections each associated with one or more pages in the multi-page product.

14. The computer-implemented method of claim 1, wherein the navigation panel includes a two-dimensional array of grids that define the plurality of selections each associated with one or more pages in the multi-page product.

15. The computer-implemented method of claim 1, wherein the image representation includes a thumbnail image of the multi-page product.

16. The computer-implemented method of claim 15, wherein the image representation includes a front cover of the multi-page product.

17. The computer-implemented method of claim 15, wherein the image representation is a perspective view of the multi-page product.

18. The computer-implemented method of claim 1, wherein the computer system includes a mobile device.

19. The computer-implemented method of claim 1, wherein the graphic user interface is enabled by a web browser, a client application, or a native application.

20. The computer-implemented method of claim 1, wherein the page view includes a web page in a web browser or a screen on a device.
